(19) United States
(12) Patent Application Publication
(10) Pub. No.: US 2020/0064317 A1
(43) Pub. Date: Feb. 27, 2020

(54) Stable Urine Indicator with Long-Term Detection

(71) Applicant: Axagarius GmbH & Co. KG, Dueren (DE)

(72) Inventors: Ralph Husmann, Dueren (DE); Jürgen Hoffmann, Dueren (DE)

(21) Appl. No.: 16/548,016

(22) Filed: Aug. 22, 2019

(30) Foreign Application Priority Data
Aug. 23, 2018 (DE) 10 2018 214 263.7

(51) Int. Cl. G01N 31/22

(52) U.S. Cl. CPC G01N 31/221

(57) ABSTRACT

The present disclosure relates to a test device for the pH-dependent detection of urine by the combined immobilization on the cellulose-containing support matrix of the pH indicator dye and the acid/base reacted with it. In addition, the present disclosure relates to a sanitary article comprising the test device according to the present disclosure, and a process for preparing the test device according to the present disclosure.

### CROSS-REFERENCE TO RELATED APPLICATION

This application claims priority to German Patent Application No. 10 2018 214 263.7 filed Aug. 23, 2018, the disclosure of which is hereby incorporated by reference in its entirety.

### BACKGROUND OF THE INVENTION

### Field of the Invention

The present invention relates to a test device for the pH-dependent detection of urine. In addition, the present invention relates to a sanitary article comprising the test device according to the invention, and a process for preparing the test device according to the invention.

### Description of Related Art

Urine is a liquid excretion product of humans, for which a simple and quick detection is of advantage, especially in the sanitary field (e.g., diapers, incontinence articles, and/or the like).

U.S. Pat. No. 4,022,211 proposes a urine detection for diapers using a wetness indicator. This wetness indicator has a water-soluble coloring agent that is dissolved by urine and migrates together with the urine into the absorbing layer of the diaper. This thereby caused coloring of the absorbing layer serves as a proof of urine. This proof has the disadvantage that it is little sensitive, because sufficient coloring agent must be dissolved and transported further in order to achieve an unambiguous coloring of the diaper. Further, the test device may not be stable, and transient moistening during the production, storage or transport may suffice to “activate” the wetness indicator. Remarkably, this proof is not selective, either, because simple water would also be detected as urine.

DE 1698247 discloses the preparation of a cellulose-containing support matrix with a pH indicator dye immobilized to the cellulose through a covalent chemical bond, and the use thereof for determining pH values, e.g., of aqueous solutions, effluents, body fluids, and/or the like. The covalent bonding of the pH indicator dye to the cellulose-containing support matrix is effected by introducing a reactive group into the pH indicator dye molecule (e.g., a 2-(hydroxysulfonyloxy)ethylsulfonyl group) and reacting it with the cellulose-containing support matrix with the action of a base (e.g., sodium carbonate and aqueous sodium hydroxide) with subsequent washing to neutral with water, followed by a drying step.

A selective urine proof is hard to provide also because urine has a high variability in its composition:
The pH value can be from 4.6 to 7.4.
The osmolarity can vary from 50 to 1200 mosmol/liter.
The color can vary from colorless to orange-red.
Urine may contain further components, such as proteins, amino acids, nitrite, leukocytes, ascorbic acid, ketone bodies, urobilinogen, bilirubin, hemoglobin, or glucose.
Urine can vary in density.

Therefore, there is a need for improved methods and devices for the detection of urine.

### SUMMARY OF THE INVENTION

The present disclosure describes improved test devices for the detection of urine that are improved with respect to at least one of the drawbacks mentioned above.

According to embodiments of the present disclosure, improvements are achieved by the embodiments and/or aspects as described herein. For example, according to the present disclosure, improvements are achieved by providing a test device according to one of the following three aspects.

In a first aspect, the present disclosure provides a test device for the pH-dependent detection of urine, wherein said test device includes a cellulose-containing support matrix comprising:
a) a pH indicator dye with a change point of from pH=0 to pH=4.5, which is immobilized to the cellulose by means of a chemical bond, and pretreated with such an amount of a solid acid that the pH indicator dye indicates the color of the acidic pH range in a dry state; or
b) a pH indicator dye with a change point of from pH=7.5 to pH=14, which is immobilized to the cellulose by means of a chemical bond, and pretreated with such an amount of a solid base that the pH indicator dye indicates the color of the alkaline pH range in a dry state.

The “pretreatment of the pH indicator dye immobilized to the cellulose by means of a chemical bond” means the treatment (e.g., reaction) of the pH indicator dye immobilized to the cellulose with a solid acid or solid base in such an amount that the pH indicator dye indicates the color of the acidic or basic pH range in a dry state. The contact with urine reverts this color change, while a color change does not take place upon contact with water alone.

In a second aspect, the present disclosure provides a test device for the pH-dependent detection of urine, wherein said test device includes a cellulose-containing support matrix comprising:
a) a pH indicator dye with a change point of from pH=0 to pH=4.5, which is immobilized to the cellulose by means of a chemical bond, wherein the cellulose has been pretreated as oxidized or sulfonated cellulose in such a way that the pH indicator dye indicates the color of the acidic pH range in a dry state; or
b) a pH indicator dye with a change point of from pH=7.5 to pH=14, which is immobilized to the cellulose by means of a chemical bond, wherein the cellulose has been pretreated as amine-derivatized cellulose in such a way that the pH indicator dye indicates the color of the alkaline pH range in a dry state.

In a third aspect, the present disclosure provides a test device for the pH-dependent detection of urine, wherein said test device includes a cellulose-containing support matrix comprising:
a) a pH indicator dye with a change point of from pH=0 to pH=4.5, which is immobilized to the cellulose by means of a chemical bond, wherein the pH indicator dye is so acidic from further acid groups that the pH indicator dye indicates the color of the acidic pH range in a dry state; or
b) a pH indicator dye with a change point of from pH=7.5 to pH=14, which is immobilized to the cellulose by means of a chemical bond, wherein the pH indicator dye is so alkaline from further alkaline reacting groups that the pH indicator dye indicates the color of the alkaline pH range in a dry state.

The inventive subject matter of these three aspects presented in advance are associated in such a way that they may realize a single general inventive idea. The inventive concept underlying all three aspects may be based on the combined immobilization on the support matrix of the indicator dye and the acid/base reacted with it. While the immobilization of the pH indicator dye to the cellulose may be effected through the chemical bond, there are three alternative possibilities for the “immobilization” of the acid/base:
1. The use of a solid acid/base
2. The use of an acidic/alkaline cellulose
3. The use of an acidified/alkalinized pH indicator dye.

All three possibilities provide for the pH indicator being activated for urine detection, since a dry test matrix is produced that shows a pH-induced color change by contacting with the urine liquid, but not by contact with water.

The test device according to the invention combines several critical advantages over the test devices known from the prior art.

One important advantage is the selectivity of the detection reaction: As set forth above, only urine as a buffered liquid with a pH of from 4.5 to 7.5 can cause the pH-induced color change. When the test matrix is wetted with water, the immobilized acid or base is merely dissolved in part or completely, and the pH set in advance by these substances does not change. Thus, the initial color of the test matrix is also retained.

Because of this selectivity, the test device also has a high stability with respect to production and storage. If an increased uptake of moisture by the test device should occur in the production process or during the storage, there will be no color change, and the test device remains in its activated form and may be used further after drying or even in a moist state.

Since the test device is based on a quick acid-base reaction with a direct color detection, it represents a direct and very quick detection method. In addition, the test device according to the invention is simple to use and to interpret and needs no additional measuring devices. Especially when used for diapers or incontinence articles, this fact increases the compliance, because the color change is quick and uncomplicated to detect.

The test device also may lead to a stable test result in the urine detection, which is long-lasting after the initial urine-induced color change. This stability is based on the immobilized pH indicator dye, which retains its strong color, e.g., does not fade out and does not show any “bleeding”, either.

Of particular importance is the fact that the test result shows a stable test result also for an only transient presence of urine. Thus, if the test matrix should come into contact with urine only briefly and thereby produce a color change, this color change is retained even after the subsequent drying of the test matrix. The drying process “immobilizes” the urine as a reaction component in the test matrix to such an extent that the test matrix still indicates the urine-induced pH change.

The test device is very robust with respect to the measuring performance: Other urine components, such as proteins, ketone bodies or glucose, do not interfere with the measurement.

The test device also has sufficient stability and also needs no cooling if the conventional reagents are used.

The test device can be prepared simply and in addition inexpensively with commercially available substances.

The test device can be integrated into established sanitary articles, such as diapers or incontinence articles, without any considerable overhead.

With respect to the individual components, those skilled in the art can rely on a wide variety of chemical substances and thus adapt the device selectively to the respective application. In particular, the selection of the solid acid/base and of the pH indicator allow for application for different detection strategies.

### BRIEF DESCRIPTION OF THE DRAWINGS

Embodiments and/or aspects of the present disclosure are additionally shown in the following drawing, and described in the following.

FIG. 1 shows a test device according to embodiments of the present disclosure;

FIG. 2A shows a disposable diaper according to embodiments of the present disclosure; and

FIG. 2B shows a disposable diaper according to embodiments of the present disclosure.

### DETAILED DESCRIPTION OF THE INVENTION

In a first “acidic” embodiment, a test device is based on an up-titration of the pH indicator, which indicates the acidic pH range because of acidically acting groups co-immobilized in advance (whether they are added externally as a solid, provided by the pH indicator, or contained in the matrix), and gets over the change range because of the urine-induced pH increase, thus indicating the color corresponding to the neutral/alkaline environment.

In the second “acidic” embodiment, the test device is based on a down-titration of the pH indicator, which indicates the alkaline pH range because of alkaline-acting groups co-immobilized in advance (whether they are added externally as a solid, provided by the pH indicator, or contained in the matrix), and gets over the change range because of the urine-induced pH decrease, thus indicating the color corresponding to the acidic/neutral environment.

According to the invention, a cellulose-containing support matrix serving as a support for the immobilized pH indicator dye is used in the test device. In one embodiment, this support matrix comprises cellulose, but may also contain other materials in addition to cellulose. Preferably, the cellulose-containing support matrix essentially consists of cellulose or consists entirely of cellulose. The cellulose represents an essential component of the support matrix, because it serves as a binding partner for the pH indicator dye.

The support matrix according to the invention is conveniently made of a cellulose-containing support material that allows liquids to pass. According to the invention, these are porous materials, in particular, which preferably absorb the liquid and thus bring a defined amount of liquid to reaction with the detection reagents.

Those skilled in the art know numerous materials and structures from the prior art that are suitable as a support matrix, and they may chose selectively depending on the concrete use.

In a preferred embodiment, the cellulose-containing support matrix is selected from the group consisting of paper, preferably filter paper; cardboard; textile woven fabrics; textile non-wovens; and textile knittings.

In a particularly preferred embodiment, the cellulose-containing support matrix is filter paper. Filter papers are inexpensive and have a good absorbency and a high absorption capacity for liquids. Therefore, they can be impregnated with the acid or base simply, for example, by soaking and subsequently drying, and can also be soaked with the urine quickly and effectively in the actual test. In addition, they can be simply cut to the desired shape and connected with the other components of a sanitary article (e.g., by an adhesive bond).

In one embodiment, the support matrix has a one-layer structure, so that all detection reagents are contained in this one layer. In an alternative embodiment, the support matrix may have a two- or more-layer structure. Thus, for example, the individual layers may have different absorbencies or absorption capacities for liquids, so that the liquid sample can be taken up more selectively, and bleeding of the support matrix can also be prevented. In addition, this allows for the spatial separation of the different detection reagents, so that chemically or physically incompatible detection reagents may be used, or the liquid sample permeating from outside can successively react with the detection reagents when passing through the individual layers.

Further, the support matrix may also have a region referred to as “waste pad”, which takes up the liquid that has passed through the support matrix. In this region, an absorbent mat, for example, or a non-woven, a blotting or filter paper or the like may be provided.

The design of the support matrix with respect to shape and depth can be one to form a small chromatographic column, in which any disturbing sample components can be separated off.

According to the invention, the pH indicator dye is bonded to the cellulose through a chemical bond undergone with this cellulose, and thus immobilized to the support matrix. The immobilization and the underlying chemical bond are defined by the condition that there is no essential disruption of the bond and thus no adverse affection of the immobilization when aqueous liquids are acting thereon. Those skilled in the art speak of color-fixed supports (thus, e.g., of color-fixed pH indicator papers), which are accordingly referred to as “non-bleeding” test devices.

According to the invention, the chemical bond for immobilizing the pH indicator dye to the cellulose is an ionic bond, a covalent bond, or a van-der-Waals bond.

A covalent bond, as is undergone, for example, by reactive dyes, is preferred, because it involves a safe and durable immobilization to the support matrix.

In a preferred embodiment, the pH indicator immobilized to the support matrix is a reactive dye.

Numerous reactive dyes acting as pH indicators are known to those skilled in the art. These may be selected from the group consisting of azo dyes, anthraquinone dyes, triphenylmethane dyes, and anthocyan dyes. The use of azo dyes is preferred.

For the determination of urine from the acid-treated pH indicator dye, it is provided according to the invention that said pH indicator dye has a change point that is from pH=0 to pH=4.5. Preferred is a change point from pH=0.5 to pH=4.0, more preferably from pH=1.0 to pH=3.5.

For the determination of urine from the alkali-treated pH indicator dye, it is provided according to the invention that said pH indicator dye has a change point that is from pH=7.5 to pH=14. Preferred is a change point from pH=8.0 to pH=13.5, more preferably from pH=8.5 to pH=13.0.

The reactive dye has at least one reactive group for covalent bonding to the cellulose. Said at least one reactive group is preferably selected from the group consisting of 2-(hydroxysulfonyloxy)ethylsulfonyl, N-methyl-N-[2-(hydroxysulf-onyloxy)ethyl]sulfonamido, monochlorotriazinyl, dichlorotriazinyl, monochloro-pyrim idyl, dichloropyrimidyl, trichloropyrimidyl, tetrachloropyrimidyl, dichloro-pyridazinyl, trichloropyridazinyl, tetrachloropyridazinyl, dichloroquinoxalinyl, di-chlorophthalazinyl, 2-(hydroxysulfonyloxy)ethylaminosulfonyl, 2,3-dichloroquin-oxaline-6-carboxylic acid, 4-chlorobenzenesulfonic acid [2-methoxyethylamide], 2-chloroquinoxaline-6-carboxylic acid, 3-chloroquinoxaline-6-carboxylic acid, 2,3-dichloroquinoxaline-6-sulfonic acid, 2,3-dichlorophthalazine-6-carboxylic acid, 2,4-dichloro-1,3,5-triazinyl, 2,4,6-trichloro-1,3,5-triazinyl, 2,4-dichloro-6-benzo-1,3,5-triazinyl, 2,4-dichloro-6-amino-1,3,5-triazinyl, and 3,5,6-trichloro-1,2,4-triazinyl.

In another embodiment of the invention, the reactive dye has at least one sulfonic acid and/or carboxylic acid group, in addition to said at least one reactive group. These groups increase the solubility of the reactive dye and facilitate the washing out of excess dye molecules or reaction by-products in the process for binding the reactive dye to the cellulose.

The solid acid of the test device serves to induce a color change to the acidic range in the pH indicator dye, and to maintain this color indicating the acidic range until the reaction with the urine takes place. As the solid acid is present as a solid, it does not volatilize, but remains as a solid within the support matrix, and allows for a long-term stable formulation.

In a preferred embodiment, said solid acid is selected from the group consisting of ascorbic acid, adipic acid, malic acid, agaric acid, amidosulfuric acid, 4-aminosalicylic acid, aspartic acid, succinic acid, benzenesulfonic acid, benzoic acid, boric acid, capric acid, cyclamic acid, 2,2-dichloroacetic acid, pamoic acid, ethanesulfonic acid, ethanedisulfonic acid, fumaric acid, gentisic acid, gluconic acid, glucuronic acid, glutamic acid, glutaric acid, glyceric acid, glycolic acid, hippuric acid, 2-hydroxyethanesulfonic acid, α-ketoglutaric acid, lactobionic acid, lauric acid, maleic acid, malonic acid, mandelic acid, lactic acid, mucic acid, sodium hydrogensulfate, oxaloacetic acid, oxalic acid, phthalic acid, 2-phosphoglyceric acid, 3-phosphoglyceric acid, propionic acid, polystyrenesulfonic acid, pyroglutamic acid, pyrrolidine-2-carboxylic acid, salicylic acid, sebacic acid, sorbic acid, sulfamic acid, p-toluenesulfonic acid, tartaric acid, cinnamic acid, and citric acid.

In a preferred embodiment, the acid is a physiologically tolerable and thus pharmaceutically acceptable substance, such as citric acid, ascorbic acid, or benzoic acid.

More preferably, the solid acid is citric acid.

For the determination of urine having a pH value of from 4.5 to 7.5, it is preferred for the solid acid to have a pKₐ value of from 1.0 to 5.0.

The solid base of the test device serves to induce a color change to the alkaline range in the pH indicator dye, and to maintain this color indicating the alkaline range until the reaction with the urine takes place. As the solid base is present as a solid, it does not volatilize, but remains as a solid within the support matrix, and allows for a long-term stable formulation.

In a preferred embodiment, said solid base is selected from the group consisting of sodium hydroxide, potassium hydroxide, lithium hydroxide, magnesium hydroxide, calcium hydroxide, sodium phosphate, sodium carbonate, and sodium sulfide, sodium hydroxide being preferred.

In a preferred embodiment, the base is a physiologically tolerable and thus pharmaceutically acceptable substance, such as sodium hydroxide or potassium hydroxide.

More preferably, the solid base is sodium hydroxide.

For the determination of urine having a pH value of from 4.5 to 7.5, it is preferred for the solid base to have a pK_{b} value of from −2.0 to 4.0.

In one embodiment of the invention, the test device is formed as a test strip, rectangular test pad, or test tape, or it has such a design that it can be taken up in an integrated test system.

The test strip can be prepared from a wide variety of materials. Preferred are anhydrous materials, such as plastic materials. The test strip preferably consists of polyvinyl chloride or polyethylene.

In another embodiment, the test device may have further support matrices.

One or more additional support matrices can be used to determine further urine parameters quantitatively or qualitatively, such as the pH value, density, protein, glucose, leukocytes, nitrite, hemoglobin, urobilinogen, bilirubin, or ketone bodies.

Conveniently, the support matrix may also be embodied for the qualitative or quantitative detection of other urine components.

In one embodiment of the invention, the above mentioned support matrix has been applied to a test strip.

In a second aspect, the invention provides a test method for urine detection, comprising the following steps:

a) soaking the support matrix with the liquid sample, preferably by immersing into the sample;

b) removing excess sample material from the support matrix, preferably by withdrawing the test strip from the sample;

c) optionally incubating the test strip for at least 5 seconds, preferably at room temperature (21° C.);

d) visually detecting the color value of the support matrix.

In a second aspect, the invention relates to a sanitary article comprising one or more of the test devices according to the invention.

Conveniently, the test device is employed in sanitary articles that may come into contact with urine in accordance with their respective application. Preferably, this sanitary article is selected from the group consisting of a diaper, diaper inlay, incontinence articles, such as incontinence pad, incontinence overlay, or incontinence pants, and a mattress pad.

More preferably, the sanitary article is a diaper and, in particular, a disposable diaper.

In a third aspect, the invention relates to a process for preparing the test device according to the invention, wherein the process comprises the following steps:
a) providing a cellulose-containing support matrix with a pH indicator dye immobilized to the cellulose by chemical bonding;
b) impregnating the dye-bearing cellulose support matrix from step a) by soaking with an impregnating solution containing water, alcohol and a solid base or a solid acid;
c) drying the dye-bearing cellulose support matrix from step b);
d) optionally trimming the dried support matrix from step c) to the desired size.

Preferably, the impregnating solution employed in step (b) contains the acid or base in a concentration of from 2 mM to 75 mM, preferably from 5 to 60 mM, more preferably from 10 to 30 mM.

The drying in step c) of the production process is preferably effected at a temperature of more than 25° C., more preferably at a temperature from 250 to 350° C.

By steps b) and c), the (pre)treatment of the pH indicator dye immobilized to the cellulose by means of a chemical bond with the solid base or solid acid is effected in such a way that the pH indicator dye indicates the color of the basic or acidic pH range in a dry state.

The cellulose-containing support matrix with a pH indicator dye immobilized to the cellulose by means of a chemical bond according to step a) can be prepared, for example, as described in DE 1698247.

A “test device” as described herein refers to all supported tests for medical and non-medical use. In such supported tests, detection reagents are embedded in the support matrix of a support that is contacted with the liquid sample. When the target analyte, e.g., the urine, is present, the reaction of the liquid sample and the reagents leads to a detectable signal, namely a color change, which can be evaluated visually or by using a device, for example, by transmission photometry, reflection photometry, or fluorescence photometry.

According to the invention, a “solid acid” means an acid that is in a solid state of matter at room temperature (21° C.). Both an organic acid and an inorganic acid may be used.

According to the invention, a “solid base” means a base that is in a solid state of matter at room temperature (21° C.). Both an organic base and an inorganic base may be used.

A “pH indicator” as used in the present invention means a substance that changes its color as a function of the pH value.

A “reactive dye” as used in the present application means a dye for dyeing cellulose. In the dyeing process, a covalent chemical bond between the dye and the functional groups of the cellulose is formed.

“Selectivity” means the ability of certain substances to preferentially select one from a number of possibilities offered for reaction. The exclusive selection is referred to as “specificity”.

The “stability” of the test device includes storage stability, stability under physical influences, such as heat, light, mechanical stress.

### Examples

### 1. Preparation of a Urine Test Device

An impregnating solution is prepared in accordance with the following recipe:

| Ingredients | Amount | |
|---|---|---|
| Citric acid | 5.0 | g |
| Ethanol | 500 | ml |
| Fully desalted water | 500 | ml |

A filter paper with an immobilized pH indicator dye (a so-called non-bleeding or color-fixed pH indication paper) is used as the support matrix.

For impregnation, the color-fixed pH indicator paper is immersed into the impregnating solution, followed by drying at 325° C. for 60 seconds. The paper may subsequently be trimmed to the desired format.

2. Urine Detection Reaction with Different Indicator Dyes

In order to identify pH indicator dyes showing a particularly clear color change, four test papers prepared according to Example 1 and based on four different indicator dyes were soaked with urine, and the color change was observed visually. The result is shown in the following Table 1.

TABLE 1
Overview of color-fixed pH indicator papers
with a color change in the acidic range

| Entry | pH change range | Color change |
|---|---|---|
| 1 | 0.0-3.5 | magenta - yellow |
| 2 | 0.0-4.0 | purple - orange |
| 3 | 1.0-5.0 | red - yellow |
| 4 | 1.5-4.5 | blue - magenta |

In the acidic pH range, the papers show color changes from magenta to yellow (entry 1), purple to orange (entry 2), red to yellow (entry 3), or blue to magenta (entry 4). The color change from blue to magenta (entry 4) is particularly good to perceive, and further experiments were performed with this paper.

### 3. Dependence of the Detection Reaction on the Buffering Strength of the Test Solution

For the urine detection, it is necessary that the test devices allow for an unambiguous urine detection even with a urine sample having a very low osmolarity. The osmolarity of urine is typically from 600 to 900 mosmol/liter. However, the osmolarity can vary from 50 to 1200 mosmol/liter depending on the liquid supply and liquid losses, above all. Accordingly, a detection of a 25 mM buffer solution is necessary to be able to also detect highly hypoosmolar urine with 50 mosmol/liter unambiguously.

In order to determine the minimum buffer amount in which the acidic-adjusted paper changes its color, the paper according to entry 4 (color change from blue to magenta) is wetted first with fully desalted water and then with different buffer solutions. The pH values of the buffer solutions correspond to the pH value of human urine (about pH 4.5-7.5).

The result is shown in the following Table 2:

TABLE 2
Color development of the pH indicator paper (entry 4 from Table 1) after
wetting with fully desalted water and different buffer solutions.

| | pH of buffer | FD | | | | | | | |
|---|---|---|---|---|---|---|---|---|---|
| Entry | solution | water | 1 mM | 5 mM | 10 mM | 20 mM | 40 mM | 80 mM | 160 mM |
| 1 ^{a)} | 4.0 | blue | blue | blue to | blue to | slightly | purple | purple to | magenta |
| | | | | very slightly | very slightly | purple | | magenta | |
| | | | | purple | purple | | | | |
| 2 ^{a)} | 5.0 | blue | blue | blue to | blue to | purple | purple to | magenta | magenta |
| | | | | very slightly | slightly | | magenta | | |
| | | | | purple | purple | | | | |
| 3 ^{a)} | 6.0 | blue | blue | blue to | blue to | purple | magenta | magenta | magenta |
| | | | | very slightly | purple | | | | |
| | | | | purple | | | | | |
| 4 ^{b)} | 7.0 | blue | blue | blue to | blue to | purple | magenta | magenta | magenta |
| | | | | slightly | purple | | | | |
| | | | | purple | | | | | |
| 5 ^{b)} | 8.0 | blue | blue | blue to | purple | magenta | magenta | magenta | magenta |
| | | | | purple | | | | | |

^{a)} Addition of buffer solution based on citric acid
^{b)} Addition of buffer solution based on phosphate salts

As the results in Table 2 show, a minimum concentration of the buffer solution of from 20 mM at pH 4.0 is necessary in order to recognize an unambiguous color reaction (entry 1). For higher pH values (entries 2-5), the color change can be recognized earlier (e.g., at lower buffer concentrations of about 5-10 mM), as expected. The color changes take place immediately and are stable over at least 24 hours.

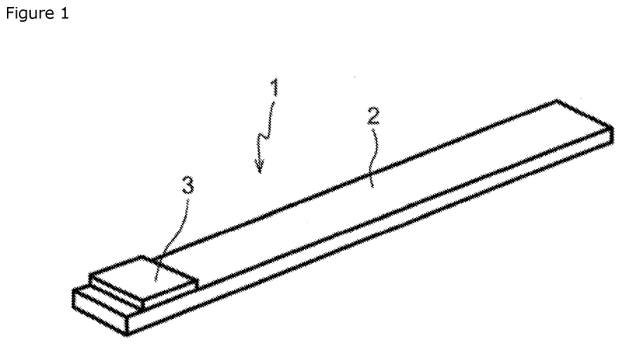

Referring now to FIG. 1, FIG. 1 shows a test device designed as a test strip 1 with a plastic strip 2 (e.g., a plastic rod) as a support, on which a support matrix 3 (e.g., a cellulose-containing support matrix with immobilized and acid/base-treated pH indicator dye) is attached. The support matrix contains the detection reagents necessary for the determination, including an organic acid and a pH indicator.

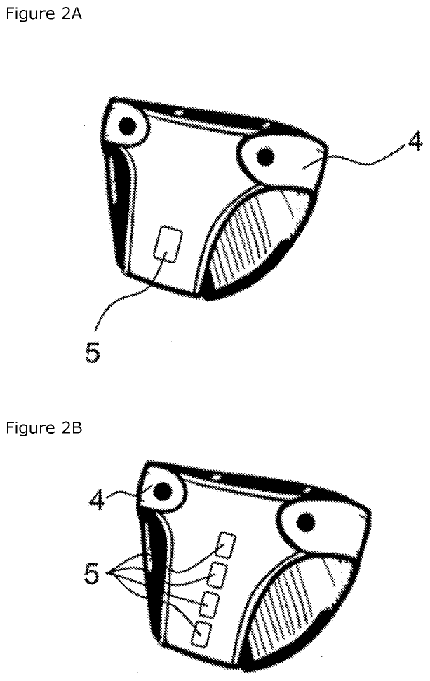

Referring now to FIG. 2A, FIG. 2A shows a disposable diaper 4 into which a test device 5 (e.g., a test device for pH-induced urine detectio) has been incorporated. This test device is attached in such a way that it is visible from outside as kind of a test window, and allows for urine detection also when the diaper is being worn.

Referring now to FIG. 2B, FIG. 2B shows a disposable diaper 4 into which several test devices 5 have been incorporated. Beyond the qualitative urine detection, the provision of several test devices 5 allows for a quantitative urine detection since the number of urine-indicating test windows allows conclusions to be drawn about the filling state of the diaper.

To those skilled in the art, further variants of the invention and their implementation result from the above disclosure, the Figures, and the claims.

Terms used in the claims, such as “comprise”, “have”, “include”, “contain” and the like do not exclude other elements or steps. The use of the indefinite article does not exclude a plural. A single means may perform the functions of several units or means mentioned in the claims. Reference symbols stated in the claims are not to be considered as limitations of the means and steps employed.

1. A test device for the pH-dependent detection of urine, wherein said test device includes a cellulose-containing support matrix comprising:
a) a pH indicator dye with a change point of from pH=0 to pH=4.5, which is immobilized to the cellulose by means of a chemical bond, and pretreated with such an amount of a solid acid that the pH indicator dye indicates the color of the acidic pH range in a dry state; or
b) a pH indicator dye with a change point of from pH=7.5 to pH=14, which is immobilized to the cellulose by means of a chemical bond, and pretreated with such an amount of a solid base that the pH indicator dye indicates the color of the alkaline pH range in a dry state.

2. A test device for the pH-dependent detection of urine, wherein said test device includes a cellulose-containing support matrix comprising:
a) a pH indicator dye with a change point of from pH=0 to pH=4.5, which is immobilized to the cellulose by means of a chemical bond, wherein the cellulose has been pretreated as oxidized or sulfonated cellulose in such a way that the pH indicator dye indicates the color of the acidic pH range in a dry state; or
b) a pH indicator dye with a change point of from pH=7.5 to pH=14, which is immobilized to the cellulose by means of a chemical bond, wherein the cellulose has been pretreated as amine-derivatized cellulose in such a way that the pH indicator dye indicates the color of the alkaline pH range in a dry state.

3. A test device for the pH-dependent detection of urine, wherein said test device includes a cellulose-containing support matrix comprising:
a) a pH indicator dye with a change point of from pH=0 to pH=4.5, which is immobilized to the cellulose by means of a chemical bond, wherein the pH indicator dye is so acidic from further acid groups that the pH indicator dye indicates the color of the acidic pH range in a dry state; or
b) a pH indicator dye with a change point of from pH=7.5 to pH=14, which is immobilized to the cellulose by means of a chemical bond, wherein the pH indicator dye is so alkaline from further alkaline reacting groups that the pH indicator dye indicates the color of the alkaline pH range in a dry state.

4. The test device according to claim 1, wherein said cellulose-containing support matrix is selected from the group consisting of paper; cardboard; textile woven fabrics; textile non-wovens; and textile knittings, wherein said cellulose-containing support matrix is preferably filter paper.

5. The test device according to claim 1, wherein said pH indicator is a reactive dye selected from the group consisting of azo dyes, anthraquinone dyes, triphenylmethane dyes, and anthocyan dyes.

6. The test device according to claim 5, wherein said pH indicator is a reactive dye with at least one reactive group for covalent bonding to the cellulose, wherein said at least one reactive group is selected from the group consisting of 2-(hydroxysulfonyloxy)ethylsulfonyl, N-methyl-N-[2-(hydroxysulfonyloxy)ethyl]sulfonamido, monochlorotriazinyl, dichloro-triazinyl, monochloropyrimidyl, dichloropyrimidyl, trichloropyrimidyl, tetra-chloropyrimidyl, dichloropyridazinyl, trichloropyridazinyl, tetrachloropyrid-azinyl, dichloroquinoxalinyl, dichlorophthalazinyl, 2-(hydroxysulfonyloxy)-ethylaminosulfonyl, 2,3-dichloroquinoxaline-6-carboxylic acid, 4-chloro-benzenesulfonic acid [2-methoxyethylamide], 2-chloroquinoxaline-6-carb-oxylic acid, 3-chloroquinoxaline-6-carboxylic acid, 2,3-dichloroquinoxaline-6-sulfonic acid, 2,3-dichlorophthalazine-6-carboxylic acid, 2,4-dichloro-1,3,5-triazinyl, 2,4,6-trichloro-1,3,5-triazinyl, 2,4-dichloro-6-benzo-1,3,5-triazinyl, 2,4-dichloro-6-amino-1,3,5-triazinyl, and 3,5,6-trichloro-1,2,4-triazinyl.

7. The test device according to claim 6, wherein said reactive dye has at least one sulfonic acid and/or carboxylic acid group, in addition to said at least one reactive group.

8. The test device according to claim 1, wherein said solid acid is selected from the group consisting of ascorbic acid, adipic acid, malic acid, agaric acid, amidosulfuric acid, 4-aminosalicylic acid, aspartic acid, succinic acid, benzenesulfonic acid, benzoic acid, boric acid, capric acid, cyclamic acid, 2,2-dichloroacetic acid, pamoic acid, ethanesulfonic acid, ethanedisulfonic acid, fumaric acid, gentisic acid, gluconic acid, glucuronic acid, glutamic acid, glutaric acid, glyceric acid, glycolic acid, hippuric acid, 2-hydroxyethanesulfonic acid, α-ketoglutaric acid, lactobionic acid, lauric acid, maleic acid, malonic acid, mandelic acid, lactic acid, mucic acid, sodium hydrogensulfate, oxaloacetic acid, oxalic acid, phthalic acid, 2-phosphoglyceric acid, 3-phosphoglyceric acid, propionic acid, polystyrenesulfonic acid, pyroglutamic acid, pyrrolidine-2-carboxylic acid, salicylic acid, sebacic acid, sorbic acid, sulfamic acid, p-toluenesulfonic acid, tartaric acid, cinnamic acid, and citric acid.

9. The test device according to claim 1, wherein said solid base is selected from the group consisting of sodium hydroxide, potassium hydroxide, lithium hydroxide, magnesium hydroxide, calcium hydroxide, sodium phosphate, sodium carbonate, and sodium sulfide.

10. The test device according to claim 1, wherein the test device is formed as a test strip, rectangular test pad, or test tape, or the test device can be taken up in an integrated test system.

11. A sanitary article comprising one or more test devices according to claim 1.

12. The sanitary article according to claim 11, wherein said sanitary article is selected from the group consisting of a diaper, a diaper inlay, incontinence articles, incontinence overlays, incontinence pants, and a mattress pad.

13. A process for preparing the test device according to claim 1, comprising the following steps:
a) providing a cellulose-containing support matrix with a pH indicator dye immobilized to the cellulose by chemical bonding;
b) impregnating the dye-bearing cellulose support matrix from step a) by soaking with an impregnating solution containing water, alcohol and a solid base or a solid acid;
c) drying the dye-bearing cellulose support matrix from step b);
d) optionally trimming the dried support matrix from step c) to the desired size.

14. The process according to claim 13, wherein said impregnating solution contains the acid or base in a concentration of from 2 mM to 75 mM.

15. The process according to claim 13, characterized in that said drying in step c) is effected at a temperature of more than 25° C.

16. The test device according to claim 1, wherein said paper is filter paper.

17. The process according to claim 13, wherein said impregnating solution contains the acid or base in a concentration from 5 to 60 mM.

18. The process according to claim 13, wherein said impregnating solution contains the acid or base in a concentration from 10 to 30 mM.

19. The process according to claim 13, wherein said drying in step c) is effected at a temperature from 250 to 350° C.
